(19) United States
(12) Patent Application Publication
(10) Pub. No.: US 2026/0161700 A1
(43) Pub. Date: Jun. 11, 2026

(54) CO-GENERATION OF DATA ITEMS WITH GENERATIVE NEURAL NETWORKS

(71) Applicant: Google LLC, Mountain View, CA (US)

(72) Inventors: Adrien Fredj Baranes, London (GB); Robert Andrew Marchant, London (GB); Triona Butler, Dingle (IE); Kristen Olsen, London (GB); Nimisha Karnatak, Oxford (GB)

(21) Appl. No.: 19/327,770

(22) Filed: Sep. 12, 2025

Related U.S. Application Data
(60) Provisional application No. 63/694,191, filed on Sep. 12, 2024.

(51) Int. Cl. G06F 16/532; G06F 16/535; G06F 16/538

(52) U.S. Cl. CPC G06F 16/532; G06F 16/535; G06F 16/538

(57) ABSTRACT

Methods, systems, and apparatuses, including computer programs encoded on computer storage media, for assisting a user with generating a content item that is customized for the preferences of the user. By generating and allowing for the iterative refinement of a relatively computationally inexpensive, text-based brief before generating the final content item, the described techniques avoid the need to generate multiple, undesired, and computationally expensive content items. As a result, the described techniques improve the operational efficiency of the computing system by generating a single content item instead of many.

### CROSS-REFERENCE TO RELATED APPLICATIONS

This application claims priority of U.S. Provisional Application Ser. No. 63/694,191 filed Sep. 12, 2024. The contents of the prior application is incorporated herein by reference in its entirety.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that performs a co-generation task for a user by making use of one or more generative neural networks.

A “co-generation task” is a task that requires assisting a user with generating a content item that is customized for the preferences of the user.

The content item can be any appropriate digital content item (e.g., image, video, text, web page, or any combination of these, e.g., image with text, video with audio, and so on) that can be presented to a user through a user device (e.g., a mobile phone, a tablet computer, a laptop computer, a desktop computer, a wearable device, a smart speaker, or other edge device).

Particular embodiments of the subject matter described in this specification can be implemented so as to realize one or more of the following advantages.

Generating a customized content item that aligns with a user's preferences directly from context information (i.e., data that characterizes the user's preferences for the content item, e.g., fonts, styles, images, colors, and so on) is a significant technical challenge. A key aspect of this challenge is effectively translating a user's preferences into the content item. For example, because users are often non-expert users of generative neural networks, a user's direct prompting to a generative neural network can result in a mismatch between a generated content item and a desired content item.

To generate a content item that aligns with user preferences, some methods require multiple attempts at generating an acceptable content item, particularly when the desired content item is complex, e.g., a high-resolution image or video. As an example, a method may have a user provide an image of famous rock climber and receive a prompt to generate an image content item displaying “the rock climber climbing at a famous rock climbing location.” The method might first generate the image content item with a dark background at a specific rock climbing location, which the user rejects. The method might then generate another image content item with a bright background at a different rock climbing location, which the user also rejects. This trial-and-error process continues until a satisfactory content item is generated. While a subset of characteristics of a generated content item may be satisfactory to the user, the lack of control and the high variability of content items between regenerations makes this iterative trial-and-error process inefficient for generating a content item that fully aligns with all of a user's preferences.

Methods that require multiple content item generation attempts using a generative neural network are computationally expensive. This is because the use of generative neural networks often involves billions of trainable parameters that must be loaded into computer memory, and a single content item generation may require a large number of computational operations that consume significant processing resources from potentially specialized hardware, e.g., one or more graphics processing units (GPUs). The processing and memory requirements scale substantially with the complexity of the content item, becoming particularly demanding when generating high-resolution images or videos. Consequently, the methods that require an iterative trial-and-error process of generating content items to yield a final content item consumes substantial computational resources, including processing cycles and memory and leads to inefficient operation of a computer system.

This specification describes techniques that can address the aforementioned challenges by generating a brief of a content item that includes a natural language description of the content and the appearance of the customized content item. Then allowing the user to iteratively modify and approve the brief to generate a final brief, which can then be used to generate the content item. That is, the described techniques process an input prompt that includes received context information using a generative neural network to generate a text-based brief of the content item. Then the describe techniques provide the brief for presentation to the user on a user device and can receive one or more user inputs modifying the brief to generate a final brief. In some cases, only after a user input approving the brief is received will an input that includes the brief be processed using another generative neural network to generate the customized content item.

By generating and allowing for the iterative refinement of a relatively computationally inexpensive, text-based brief before generating the final content item, the described techniques avoid the need to generate multiple, undesired, and computationally expensive content items.

Additionally, because the described techniques improve a user's ability to translate preferences for a content item into a generated content item through the modification of the brief to generate a final brief, features of the described techniques that enhance user modification of the brief (e.g., through improved generation of the input prompt) improves the computational efficiency of the system.

For example, by generating, from the context information, a user interface presentation that presents information derived from the context information; and then providing the user interface presentation for presentation to the user on the user device, the described techniques improve users' ability in formulating their preference in the brief. For example, the user's preferred colors can be presented in an interactive color palette in a graphical user interface of laptop, allowing the user to easily select the precise colors to be used in the content item. The presentation of information enhances user control in generating a content item aligned with the user's preferences by allowing the user to review, modify, and confirm all information derived from context information through an intuitive interface before generating the input prompt based on information presented in the user interface presentation and then generating the brief.

As another example, the described techniques inclusion of processing each of the one or more images (included in the context information) using a computer vision neural network to generate a description of the image is advantageous for users who have a clear visual concept but lack the specialized design jargon to describe it. By generating text descriptions of images and including, in the input prompt, the descriptions of the one or more images, the described techniques allow for a more accurate translation of the user's visual preferences into the input prompt (and therefore the subsequently generated brief). This is because a user may be able to recognize a desired aesthetic, e.g., a particular composition in an image, but may not know the technical terms, e.g., “rule of thirds,” required to request it from the generative neural network.

As another example, by processing at least a portion of the context information using the generative neural network to generate at least a portion of the information presented in the user interface presentation, e.g., suggested brand values or target audiences, the described techniques reduce the cognitive load on the user and provides helpful starting points, which is especially useful for novice designers. This information generated by processing at least a portion of the context information, once confirmed or modified by the user in the interface, can be included in the input prompt used to generate the brief. Because a novice user might not otherwise consider including such information, its inclusion results in a brief that is better aligned with the user's preferences without the user needing to explicitly initially provide the information.

The described techniques for generating the brief result in a final, user-approved brief that is better aligned with the user's preferences. By then processing an input that includes this well-aligned and reliable brief to generate the content item, the described techniques ensure that the resource-intensive content generation step is performed only once.

As a result of the above, the described techniques improve the operational efficiency of the computing system by conserving computational resources.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1A shows a brief generation system.

FIG. 1B is an example brief and corresponding content item.

FIG. 2 is a flow diagram of an example process for generating a brief to be provided for presentation to a user on a user device.

FIG. 3 is a flow diagram of an example process for generating, from the context information, an input prompt.

FIG. 4 is an example user interface presentation.

FIG. 5 is a visual flow diagram of an example process for generating a content item.

Like reference numbers and designations in the various drawings indicate like elements.

### DETAILED DESCRIPTION

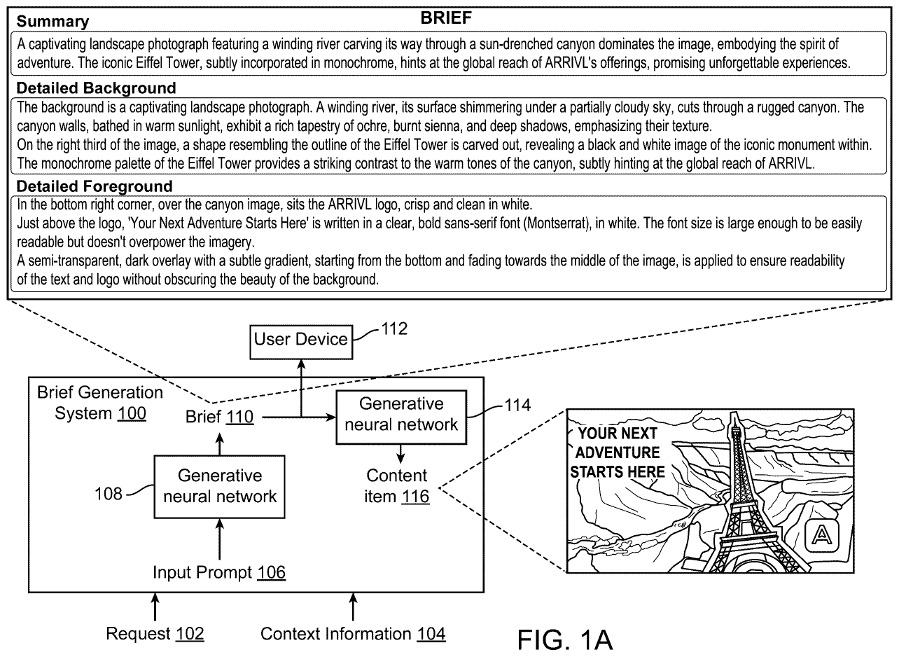

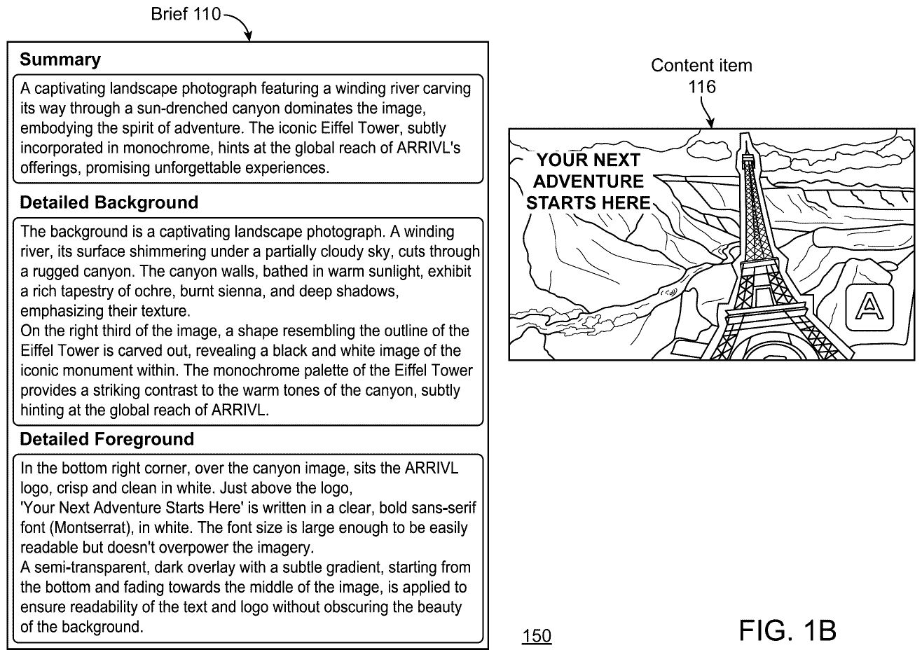

FIG. 1A shows a brief generation system 100. The system 100 is an example of a system implemented as computer programs on one or more computers in one or more locations, in which the systems, components, and techniques described below can be implemented.

The brief generation system 100 receives a request 102 to generate a customized content item 116 for a user and, in response, provides a brief 110 of the customized content item 116 for presentation to the user on a user device 112.

The content item 116 can be any appropriate digital content item that can be presented to a user on a user device 112.

For example, the digital content item can be an image, a video, or an audio signal.

As another example, the digital content item can be a multi-modal content item, e.g., an image that includes text, a video with corresponding audio, and so on.

As another example, the digital content item can be an electronic document, e.g., a web page.

As another example, the digital content item can be an online advertisement. Examples of online advertisements include visual formats like image banners on web pages or posts on message boards; video formats like video advertisements during video playback; or audio formats such as commercial breaks during music or podcast playbacks.

The user device 112 can be any of variety of types of user devices that can present the content item, e.g., a smartphone, a tablet computer, a laptop computer, a desktop computer, a wearable device, a smart speaker, or other edge device.

Generally, the brief 110 includes a natural language description of the content and appearance of the content item 116.

As a particular example, the brief 110 can include a natural language summary of the content item 116 and natural language descriptions of the background and foreground of the content item.

More specifically, the system 100 can use a generative neural network 108 to generate, from context information 104, a brief 110 of a content item 116 that will be presented to the user on the user device 112.

Context information 104 is the initial set of data the system 100 receives to begin the brief 110 generation process and can be any data that characterizes the user's preferences for the content item 116. The context information 104 can include raw data provided by a user, e.g., an image, as well as pre-composed data, e.g., a target audience (i.e., a text description of a target audience) retrieved from system memory. Some examples of the context information 104 include colors, fonts, styles, images, audio, video, logos, brand values, target audience, styles, and so on

The system 100 can receive the context information 104 from the user, system maintained data, or another system. For example, the system 100 can receive user uploaded context information 104 via a user device 112, the system 100 can retrieve maintain data of the user's context information 104 from previous sessions with the user, or the system 100 can obtain context information 104 from a server (e.g., obtain context information 104 from a website over the internet).

To generate the brief 110 from the context information 104, the system 100 generates an input prompt 106 from the context information 104 for the generative neural network 108. The system 100 then processes the input prompt 106 using the generative neural network 108 to generate the brief 110.

Generally, the prompt 106 includes natural language instructions to generate the brief and also includes information derived from the context information 104.

The system 100 processes the context information 104 to generate the information derived from the context information 104. The derived information from the context information 104 used to generate the input prompt 106 includes both a representation of the initial context information 104 and any new data the system 100 generates based on the context information 104, e.g., the system processes an image to identify a ‘style’ description.

For example, if the context information 104 indicates a preference for the colors red and green, the input prompt 106 could include “Generate a brief for a content item. The main colors I would like included in the content are red and green.”

As another example, if the context information 104 includes an image of a hiker at the peak of a mountain, the information derived from the context information 104 can include the style “warm sunlight” present in that image. The input prompt 106 could then include “Generate a brief for a content item. I would like the style ‘warm sunlight’ included in the brief.” To generate the style information, the system 100 can process the image included in the context information 104 using the generative neural network to identify one or more styles present in the image. Further details of how the system derives information from the context information 104 are described below.

The generative neural network 108 can have any of a variety of neural network architectures. That is, the generative neural network 108 can have any appropriate architecture in any appropriate configuration that can process at least the input prompt 106 to generate a brief 110, including fully connected layers, convolutional layers, recurrent layers, attention-based layers, and so on, as is appropriate. For example, the generative neural network 108 can be a language model neural network or a multi-modal language model neural network. Examples of such generative neural networks can include the PaLM-2, PaLI, and Gemini models.

After generating the brief 110, the system 100 provides the brief 110 of the customized content item 116 for presentation to the user on the user device 112.

For example, for a user of a smartphone, the system 100 can present the brief 110 in a user interface (e.g., a smartphone application that includes elements like buttons, icons, menus, and so on) within the display screen of the smartphone after generating the brief 110.

In some cases, after presenting the brief 110 to the user, the system 100 will process an input that includes the brief 110 using another generative neural network 114 to generate the customized content item 116.

The other generative neural network 114 can be the same generative neural network or a different generative neural network from the generative neural network 108 described above. For example, the other generative neural network 114 can also be the language model or multi-modal language model. Or the other generative neural network 114 can be a different type of generative neural network, e.g., a diffusion model, generative adversarial network (GAN) model, and so on.

In some cases, prior to generating the content item 116, the system 100 receives, from the user device 112, a user input approving the brief 116. Then, in response to receiving the user input approving the brief, the system 100 processes the brief 110 using the other generative neural network 114 to generate the customized content item 116.

For example, after presenting the brief 110 to the user on the user device 112 (e.g., in a user interface on a smartphone display), the system 100 can receive a user selection of a “approve” button (i.e., user input) and, in response, process an input that includes the brief 110 using the other generative neural network 114 to generate the content item 116.

In some cases, the system 100 receives, from the user device, one or more user inputs modifying the brief to generate a final brief.

For example, in some cases, after generating the brief 110, the system 100 can present the brief 110 to the user in a user interface of the user device 112 and allow the user to submit edits modifying the brief 110 to generate a final brief 110.

For example, after reviewing an initial generated brief 110 presented through a user interface, the user can make changes to the initial brief 110 via the user interface. That is, the user interface could include buttons, sliders, and so on that allow the user to modify information derived from the context information 104. Then, the system 100 can generate a new input prompt 106 corresponding to the modified information derived from the context information 104 to generate a final brief 110 using the generative neural network 108.

As a particular example, the user interface could include drop down selectors for two preferred colors. The presented brief 110 may correspond to the initial selections of red and green, but the user can reselect these colors to be black and yellow through interaction with a user interface, which will then be incorporated into the new input prompt 106 and therefore the final brief 110 (i.e., the user submits edits modifying the brief 110).

Optionally, after generating the final brief 110, the system 100 can then provide the final brief 110 for use in generating the customized content item 116.

In some cases, after generating the final brief 110, the system 100 can then use the other generative neural network 114 to generate the content item 116 from the brief 110.

For example, the system 100 can provide an input prompt derived from the brief 110 to the other generative neural network 114 to cause that generative neural network 114 to generate a content item 116 that has properties described by the brief 110.

FIG. 1B is an example brief and corresponding content item. In particular, FIG. 1B shows the example brief 110 and example content item 116 of FIG. 1A.

The brief 110 is a natural language description of the content and appearance of the customized content item 116 and includes a summary section, detailed background section, and detailed foreground section.

The content item 116 reflects the characteristics elaborated in the brief 110. That is, the content item 116 reflects the summary, and detailed background and foreground present in the brief 110.

The structured and detailed nature of the brief 110 enables the accurate generation of the content item 116. For example, the ‘Detailed Background’ section of the brief 110 specifies a landscape with a winding river and a monochrome Eiffel Tower on the right side, which is precisely reflected in the background imagery of the content item 116. Similarly, the ‘Detailed Foreground’ section specifies the exact text, font, color, and location of the logo and headline, which is also faithfully rendered in the content item 116. Because the brief provides specific instructions for both background composition and foreground elements, the resulting content item 116 is an accurate realization of the creative plan detailed in the brief 110.

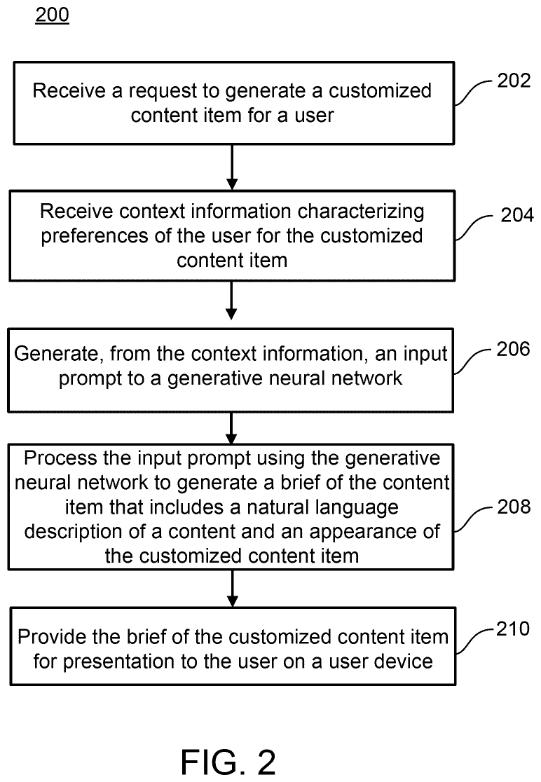

FIG. 2 is a flow diagram of an example process 200 for generating a brief to be provided for presentation to a user on a user device. For convenience, the process 200 will be described as being performed by a system of one or more computers located in one or more locations. For example, a brief generation system, e.g., the brief generation system 100 of FIG. 1A, appropriately programmed in accordance with this specification, can perform the process 200.

The system receives a request to generate a customized content item for a user (step 202).

A request is a user input that initiates the content item generation process, and the system can receive it from a user (e.g., through a user device interaction or an application programming interface (API) call), or another system. For example, the system can receive the request when a user clicks a “Generate content” button in a web interface on a mobile phone.

As described above, a customized content item for a user can be any appropriate digital content item that can be presented to a user through a user device. Some examples of possible customized content items include images with text, videos with audio, web pages and so on.

The system receives context information characterizing preferences of the user for the customized content item (step 204).

As described above, the context information characterizes preferences of the user for the customized content item. Some examples include logos, fonts, colors, images, videos, audio, target audiences, goals, and so on.

The system generates, from the context information, an input prompt to a generative neural network (step 206).

As described above, the input prompt includes instructions for the generative neural network that guides the generation of the brief. Generally, it is a structured sequence of data of any modality (e.g., text, image, video, audio, or any combination of these) synthesized from the context information. The input prompt is generated by combining the elements of the context information into a single, coherent instruction set for the neural network.

For example, the system can incorporate user's specified colors, and image from the context information into a natural language instruction within the prompt, such as “Generate a brief using the color palette {LIST OF COLORS}. Take inspiration from {IMAGE}.”, where “{LIST OF COLORS}”, and “{IMAGE}” are placeholders for portions of the context information.

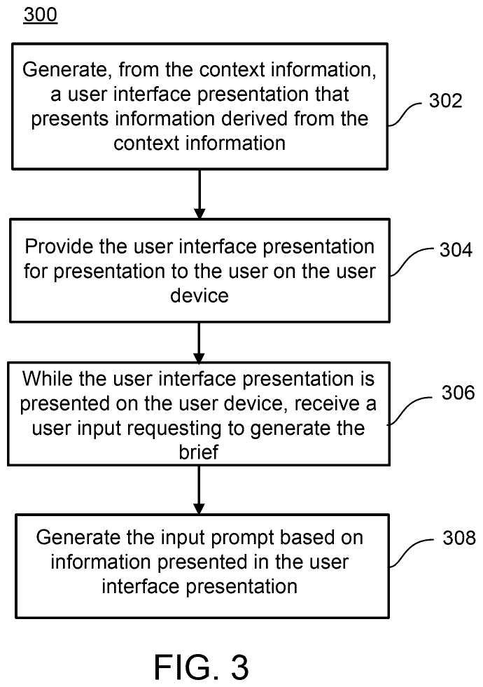

In some cases, the system generates an input prompt from the context information based on information presented in a user interface presentation. That is, the system can first generate a user interface that organizes and presents information derived from the context information to the user. After the user interacts with or approves the information in the interface, the system generates the input prompt based on the state of the information presented in that interface. Further details for generating, from the context information, an input prompt are described below with reference to FIG. 3.

FIG. 3 is a flow diagram of an example process 300 for generating, from the context information, an input prompt. For convenience, the process 300 will be described as being performed by a system of one or more computers located in one or more locations. For example, a brief generation system, e.g., the brief generation system 100 of FIG. 1A, appropriately programmed in accordance with this specification, can perform the process 300.

Example process 300 provides an example implementation for generating an input prompt, as described in step 206 of FIG. 2. This example process uses a user interface as an intermediary to enable a user to confirm, modify, and augment the information derived from the context information before the system synthesizes that information into an input prompt for the generative neural network.

The system generates, from the context information, a user interface presentation that presents information derived from the context information (step 302).

As described above, context information can be any data that characterizes the user's preferences for the content item. For example, the context information can include images, videos, fonts, colors, and so on.

A user interface presentation is an interface for the user that organizes and presents the information derived from the context information as various elements to the user in an interactive format, e.g., graphical user interface that displays the various elements of the context information.

To generate the user interface, the system can, for example, process the context information and use it to populate a pre-defined interface template.

For example, if the user provides a set of colors as part of the context information, the system can generate a user interface that includes a color palette component displaying those exact colors.

In some implementations, the system processes at least a portion of the context information using the generative neural network to generate at least a portion of the information presented in the user interface presentation.

For example, the system can process a prompt using the generative neural network that includes context information, e.g., the colors, fonts, and images included in the context information, to generate a text description of a target audience that the system can then present in the user interface presentation in a text field.

As another example, the system can process a prompt using the generative neural network that includes context information, e.g., logo, images, webpage, included in the context information, to generate a text description of a brand values that the system can then present in the user interface presentation in a text field.

As another example, the system can process a prompt using the generative neural network that includes context information, e.g., an image included in the context information, to generate a style slider i.e., a user interface control element for a specific stylistic attribute that the generative neural network has identified from the image, that the system can then present in the user interface.

In some implementations, when the information presented in the user interface includes one or more images, the system processes each of the one or more images using a computer vision neural network to generate a description of the image.

For example, the system can process each image included in the context information using a computer vision neural network to analyze each image to describe significant objects in the image and identify their respective coordinates. Then, the system can present in the user interface presentation the images and call computer functions to generate bounding rectangles over the images that correspond to the descriptions of objects. When the user selects the rectangles (e.g., clicking the rectangle, hovering over the rectangle, and so on) the system can display the description corresponding to the rectangle.

The computer vision neural network can have any of a variety of neural network architectures. That is, the computer vision neural network can have any appropriate architecture in any appropriate configuration that can process at least the image to generate a text description of the image, including fully connected layers, convolutional layers, recurrent layers, attention-based layers, and so on, as is appropriate. For example, the computer vision neural network can be a vision language model neural network or a multi-modal language model neural network. Examples of such generative neural networks can include the Flamingo, PaLI, and Gemini models. In some cases, the computer vision neural network is the generative neural network.

As described above, the information derived from the context information includes a representation of the initial context information (e.g., colors, fonts, images, and logos) and can also include new data determined by the system based on that context information (e.g., an target audience, brand values, image styles, or image descriptions). In some implementations, data that the system could determine, such as a target audience description, may instead be provided by the user or retrieved from system memory as part of the initial context information.

For example, while the system can generate a description of a target audience, a user can also provide a detailed target audience description as part of the initial context information. As another example, a target audience description that was generated by the system in a previous session can be stored in system memory and provided as part of the context information for a subsequent session.

The system provides the user interface presentation for presentation to the user on the user device (step 304).

For example, the system can transmit the user interface presentation over a network to be rendered in a web browser or native application on various devices. The presentation can be designed to adapt to different screen sizes, appearing as a single-column, scrollable view on a smartphone, a two-column layout on a tablet, or a multi-panel layout on a laptop computer.

The system, while the user interface presentation is presented on the user device, receives a user input requesting to generate the brief (step 306). That is, after the user has reviewed and is satisfied with the information shown in the user interface, the user provides a user input to the system to initiate the brief generation process.

For example, while viewing the interface in a mobile application on a smartphone, a user can tap a “Generate Brief” button that is persistently displayed at the bottom of the screen.

As another example, a user on a tablet can interact with a dedicated control panel on the screen and click a “Create Brief” icon to submit the request.

As another example, while using a web application on a laptop, the user can click a “Generate” button with their mouse or use a keyboard shortcut to request the brief.

In some implementations, prior to when the system receives the user input requesting to generate the brief, the system receives one or more user inputs representing modifications to the information presented in the user interface presentation.

For example, the user interface can present a color palette, and the user can provide a user input (e.g., a mouse click) to modify this information by selecting a different color from the palette before requesting to generate the brief.

As another example, the user interface can present a text field populated with a description of a target audience. The user can provide inputs (e.g., keyboard inputs) to modify this information by editing the text in the text field.

As another example, the user interface can present one or more slider controls corresponding to stylistic preferences derived from provided images. The user can provide an input to modify this information by adjusting the position of a slider (e.g., touch drag) to increase or decrease the influence of a particular style.

In some implementations, when the information presented in the user interface includes one or more images and the system processes each of the one or more images using a computer vision neural network to generate a description of the image, the one or more user inputs representing modifications to the information presented in the user interface presentation for these image descriptions can be user inputs that modify the text descriptions in an editable text field.

The system generates the input prompt based on information presented in the user interface presentation (step 308).

To perform step 308, the system can, e.g., scan the current state of all the interactive elements in the user interface (e.g., text fields, slider positions, and selected images) and extract the data from these elements. Then, the system can synthesize this data into a single, structured input prompt for the generative neural network.

For example, when the information presented in the user interface includes one or more images that the system processed using a computer vision neural network to generate respective descriptions of the images, then the system can include in the input prompt the descriptions of the one or more images.

As another example, the system can use a pre-defined prompt template with placeholders, e.g., “Generate a brief. The main color is {COLOR}. The target audience is {TARGET AUDIENCE}.” The system then populates the placeholders, e.g., “{COLOR}” and “{TARGET AUDIENCE}”, with the information currently present in the corresponding user interface elements.

Returning to FIG. 2, after the completion of step 206, the system processes the input prompt using the generative neural network to generate a brief of the content item that includes a natural language description of a content and an appearance of the customized content item (step 208).

As described above, the generative neural network can have any of a variety of neural network architectures. That is, the generative neural network can have any appropriate architecture in any appropriate configuration that can process an input sequence to generate an output sequence, including fully connected layers, convolutional layers, recurrent layers, attention-based layers, and so on, as is appropriate.

In some cases, the generative neural network is a pre-trained neural network (i.e., the system or another system has previously determined the values of the trainable parameters of the neural network through training on large data sets for one or more general tasks, e.g., next token prediction, image captioning, text-image alignment, and so on).

In some cases, the generative neural network processes a sequence of tokens to generate, as output, a sequence of tokens from a vocabulary, and the tokens can represent any modality of data such as text, image, audio, video and so on. For example, the generative neural network can be one that belongs to the Gemini family of neural networks, the Gemma family of neural networks, and so on.

In some implementations, the generative neural network is configured to process a sequence of tokens to auto-regressively generate an output sequence of tokens. That is, in some implementations, the generative neural network can be referred to as an auto-regressive neural network when the generative neural network auto-regressively generates an output sequence of tokens. More specifically, the auto-regressively generated output is created by generating each particular token in the output sequence conditioned on a current input sequence that includes any tokens that precede the particular token in the output sequence, e.g., the tokens that have already been generated for any previous positions in the output sequence that precede the particular position of the particular token.

For example, the generative neural network can be an auto-regressive Transformer-based neural network that includes (i) a plurality of attention blocks that each apply a self-attention operation and (ii) an output subnetwork that processes an output of the last attention block to generate the score distribution.

In this example, the generative neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Team, G., Mesnard, T., Hardin, C., Dadashi, R., Bhupatiraju, S., Pathak, S., Sifre, L., Rivière, M., Kale, M. S., Love, J. and Tafti, P., 2024. Gemma: Open models based on gemini research and technology. arXiv preprint arXiv:2403.08295; and Team, G., Anil, R., Borgeaud, S., Alayrac, J. B., Yu, J., Soricut, R., Schalkwyk, J., Dai, A. M., Hauth, A., Millican, K. and Silver, D., 2023. Gemini: a family of highly capable multimodal models. arXiv preprint arXiv:2312.11805.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

Further in some cases, the generative neural network is a fine-tuned neural network (i.e., the system or another system updates previously determined pre-trained values of the trainable parameters of the generative neural network through further training on a task specific data set). During fine-tuning, the generative neural network's parameters (or a subset of them) are further adjusted, adapting the general knowledge acquired during pre-training to the specific nuances of processing an input sequence generate from a code input to generate an output sequence defining a natural language outline for the code input. This approach can improve the performance of generating natural language outlines while requiring less data and computational cost than training the generative neural network from scratch.

In some implementations, the generative neural network processes an input sequence that includes a prompt (e.g., zero-shot prompt, few-shot prompt, chain-of-thought prompt, and so on), which can remove the need for fine-tuning when the generative neural network is a pre-trained neural network.

Generally, the input sequence can represent any type of data (e.g., text, image, audio, video, or any combination of these). For example, the input sequence can be the result of the system tokenizing text, image, audio, video, or any combination of these.

As a particular example, for text, the system can use a text tokenizer to partition the text into a sequence of word or sub-word tokens. For example, the system can apply the Byte-Pair Encoding (BPE), WordPiece, or SentencePiece tokenizers to divide the natural language text data into tokens from a vocabulary.

As another particular example, for images, the system can partition the image into a grid of fixed-size patches, e.g., 16×16 pixel patches. Each patch is then treated as a single token and ordered into a sequence, for example, according to a raster scan order.

As another particular example, for audio, the system can first convert a raw audio waveform into a time-frequency representation, e.g., a spectrogram. The system can then partition the spectrogram into a sequence of frames, where each frame is treated as a token.

As another particular example, for video, the system can sample frames from the video at a particular rate. Each sampled frame can then be processed as a token. For instance, the system can partition each sampled frame into a grid of patches, with the final input sequence being a flattened sequence of all patches from all sampled frames, ordered temporally.

So, for the system to process the input prompt using the generative neural network to generate a brief of the content item, the system can, for example, first use one or more tokenizer(s) to convert the input prompt into a sequence of tokens. The system then processes this token sequence using the generative neural network, which can auto-regressively generate an output sequence of new tokens. The system then de-tokenizes this output sequence to produce the natural language text of the brief.

In some cases, the brief can include a natural language summary of the content item. For example, the example brief 110 of FIG. 1B includes the summary “A captivating landscape photograph featuring a winding river carving its way through a sun-drenched canyon . . . ”

In some cases, the brief includes a natural language description of a background of the customized content item. For example, the example brief 110 of FIG. 1B includes the “The background is a captivating landscape photograph. A winding river, its surface shimmering under a partially cloudy sky, cuts through a rugged canyon . . . ”

In some cases, the brief includes a natural language description of a foreground of the customized content item. For example, the example brief 110 of FIG. 1B includes the description of the foreground “‘Your Next Adventure Starts Here’ is written in clear, bold sans-serif font, in white. The font size is large enough be easily readable but does not overpower the imagery.”

The system provides the brief of the customized content item for presentation to the user on a user device (step 210).

The system can present the brief to the user in any of a variety of ways depending on the capabilities of the user device. For example, on a user device with a screen, such as a smartphone, tablet computer, or desktop computer, the system can render the brief as formatted text in a graphical user interface of an application or a web page. In this interface, for example, the summary, background, and foreground descriptions can be presented in distinct, collapsible sections.

As another example, for a user device with audio output capabilities, the system can use a text-to-speech engine to read the brief aloud to the user, allowing the user to request different sections of the brief using voice commands.

In some cases, after the system provides the brief of the customized content item for presentation to the user on a user device, the system can process an input that includes the brief using a generative neural network to generate the customized content item. For example, the system can be configured to parse the natural language of the brief's summary, background, and foreground sections and assemble them into a detailed text prompt for the generative neural network.

As described above, the generative neural network that generates the content item can be the same generative neural network the system uses to generate the brief or a different generative neural network. For example, the generative neural network used to generate the content item can also be the language model or multi-modal language model used to generate the brief. Or the generative neural network used to generate the content item can be a different type of generative neural network, e.g., a diffusion model, generative adversarial network (GAN) model, and so on.

For example, the generative neural network that generates the content item can be selected based on the modality of the desired content item. To generate a text-based content item, the network can be a language model, for example, a model from the Gemini or Gemma family of neural networks. To generate an image, the network can be a text-to-image diffusion neural network or a multi-modal model capable of image generation. Similarly, to generate audio or video, the network can be a text-to-audio or text-to-video model, respectively. For a multi-modal content item that includes a combination of text, images, or other media, a multi-modal generative neural network, e.g., from the Gemini family, can be used.

Generally, the input is any appropriate input that the receiving generative neural network requires to generate the content item from the brief.

For example, for a language model generating a text content item, the input can be a natural language prompt that includes the text of the brief.

As another example, for a diffusion neural network generating an image content item, the input can include a text prompt derived from the brief as well as other conditioning information, for example, an initial noisy image.

In some implementations, the system receives, from the user device, a user input approving the brief, and, in response to receiving the user input approving the brief, the system processes the brief using the generative neural network to generate the customized content item.

Generally, the user input can be any appropriate user input that the device can process, for example, a touch gesture on a touchscreen, a click from a mouse, a keystroke from a keyboard, or a voice command received by a microphone.

For example, a user on a smartphone can review the brief in an application. After reading the text, the user can provide the approval input by tapping an on-screen button labeled “Approve and Generate Content.” In response to receiving the signal from this user input, the system can process the brief using a text-to-image generative neural network and displays the final generated content item image on the smartphone's screen.

As another example, a user on a tablet computer can view the brief in a dedicated panel on the left side of the screen, with a placeholder panel on the right side. The user can approve the brief by clicking a “Create Visual from Brief” button. In response, the system generates the content item and renders it in the placeholder panel.

As another example, a user on a desktop computer can interact with a web-based application where the brief is shown in a central column. The user can provide the approval input by clicking an “Approve” button with a mouse. Upon receiving the approval, the system can generate a thumbnail of the customized content item in an output panel. The user can then click the thumbnail to view the content item in full resolution or download it.

As another example, a user interacting with a smart speaker can have the brief read aloud by a text-to-speech engine. After hearing the contents, the user can provide the approval input through a voice command, e.g., by saying “Approve brief.” The system's natural language understanding component processes the command, and in response, the system generates the content item and can provide an audible confirmation that the item has been created and saved.

In some implementations, the system receives, from the user device, one or more user inputs modifying the brief to generate a final brief.

Generally, the user inputs can be any appropriate interaction with the user device, for example, keyboard inputs for editing text, touch or mouse inputs for interacting with graphical user interface elements, or voice commands for specifying changes.

In some cases, modifying the brief includes the user directly editing the natural language text of the brief. For example, the system can present the brief in an editable text field, allowing the user to rewrite sentences, add new descriptions, or delete portions of the text. So, the user inputs are keyboard strokes for typing and deleting text, as well as mouse or touch inputs for selecting, cutting, and pasting text within the interface.

In other cases, modifying the brief includes the user indirectly modifying the brief by changing the information derived from the context information that was used to generate it.

For example, in this process of modifying the brief, the system can present the information derived from the context information in an interactive user interface, as described above. The user can then modify the information derived from the context information within this interface. The system can then regenerate the brief from the modified presented information. For example, after reviewing an initial brief, a user can navigate back to the user interface to confirm, modify, or augment the information derived from the context information. Then, after iteratively refining this information, the user can request that the system regenerate the brief, which results in a new, modified final brief based on the updated information.

In some implementations, the system provides the final brief for use in generating the customized content item. That is, after the final brief is generated, e.g., through an iterative modification process, the system makes it available as an input to a downstream content generation process. For example, the final brief can be sent to an automated, template-based content generation system. The content generation system can be configured to parse the natural language of the brief for keywords and structural commands, and then populate a pre-defined content template with corresponding stock assets, thereby generating the content item without using a generative neural network. For example, the system can parse the keyword ‘canyon’ from the brief's background description and retrieve a corresponding stock image of a canyon, placing it in the background layer of an image template.

In some implementations, the system processes an input that includes the final brief using a generative neural network to generate the customized content item. The generative neural network can be the generative neural network described above that generates the content item.

The input, as described above, can be any appropriate input required by the generative neural network, for example, a natural language prompt that includes the text of the brief or a text prompt combined with other conditioning information, as described above.

The process of, receiving one or more inputs modifying the brief to generate a final brief that the system processes using a generative neural network to generate a customized content item provides a significant technical advantage by improving the computational efficiency of the system. The generation of complex content items, such as high-resolution images or videos, by a generative neural network is a resource-intensive and computationally expensive task. By allowing the user to finalize their creative intent in the low-cost text domain of the brief first, the system avoids generating multiple, undesired content items. This method ensures that the computationally expensive content generation network is invoked only once with a reliable, user-approved input, and conserves significant computational resources, including processing power and memory, which reduces latency for the end-user, and improves the overall operational efficiency of the system.

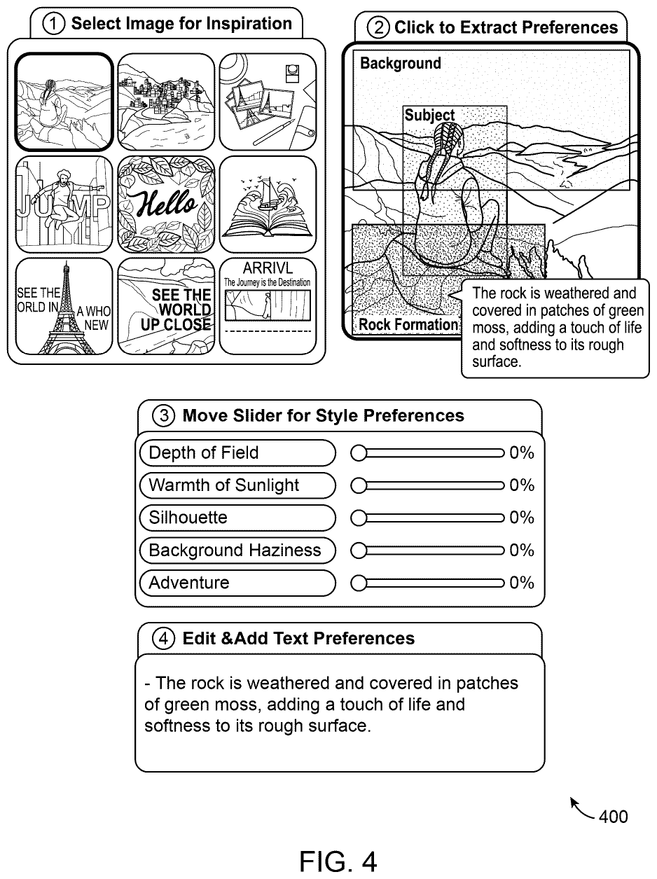

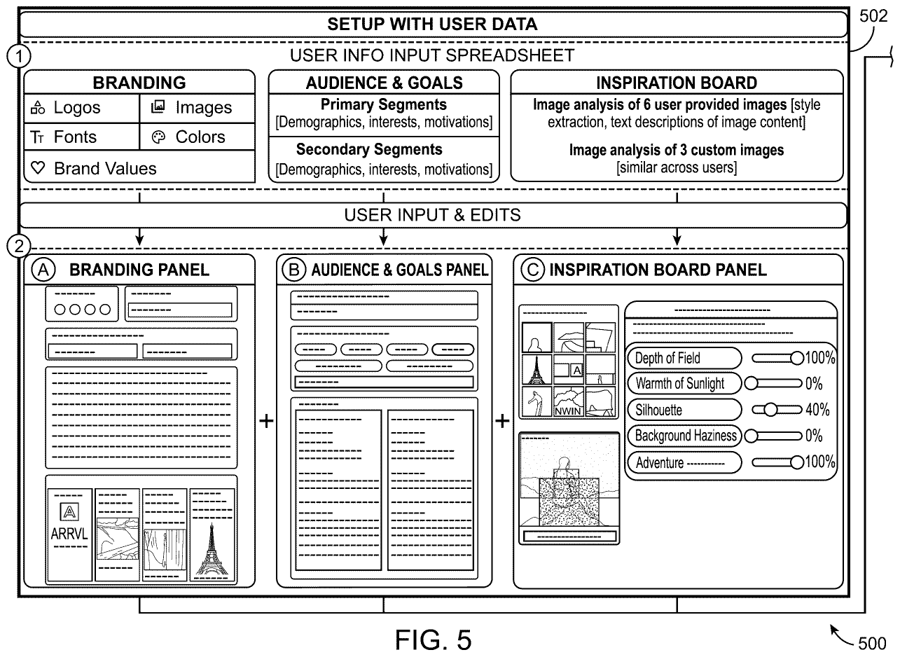

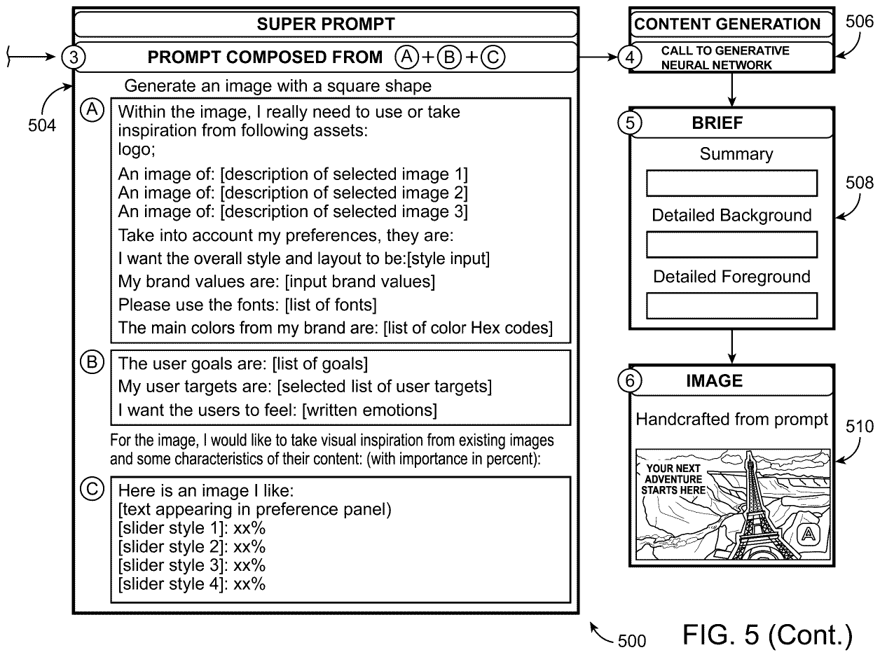

FIG. 4 is an example 400 of a user interface presentation that presents information derived from the context information. This example provides a detailed example view of an implementation of the ‘inspiration board panel’ to be described in example 500 of FIG. 5 below.

In particular, the user interface presents images that are part of the context information. The leftmost panel (labeled “1”) displays thumbnails of images present in the context information.

In response to a user selection of an image, the system processes the image using a computer vision neural network to generate a natural language description of portions of the image. The middle panel (labeled “2”) displays identification of portions of the image and creation of bounding rectangles for these portions, e.g., as described above. The bottom right panel (labeled “4”) shows, in response to the user hovering over a portion of an image, the text description of the portion of the image that the user can modify, e.g., as described above.

In particular, when a user hovers a cursor over one of these bounding rectangles, the system can automatically display the corresponding text description without requiring a click. If the user then clicks on the rectangle, the system can concatenate, or adds, the description to a separate, editable text preference panel (i.e., panel 4). The user can then directly edit any of the captured text descriptions within this panel to further refine their preferences. Finally, when the user requests to generate the brief, all the text preferences gathered and edited in this panel are incorporated into the input prompt.

The right top panel, labeled “3,” displays sliders for stylistic preferences that are dynamically generated and initialized based on the selected image. The system processes the selected image, for example using the computer vision neural network, to identify key stylistic attributes present in the image and generates a unique set of sliders corresponding to these attributes. For example, one image might generate sliders for “Warmth of Sunlight” and “Depth of Field,” (displayed in FIG. 4) while another might generate sliders for “Color Vibrancy” and “Texture Detail” (not displayed in FIG. 4).

This allows a user to “extract stylistic inspiration” by seeing a visual concept decomposed into multiple adjustable parameters. The initial position of each slider is also set based on the prominence of that attribute in the image. For instance, the “Warmth of Sunlight” slider might be set to 30% initially. The user can then adjust the slider to increase or decrease the influence of that specific style. When the user decides to generate the brief, the final adjusted values from these dynamically generated sliders are incorporated into the input prompt.

FIG. 5 is a visual flow diagram of an example 500 process for generating a content item.

The system receives context information characterizing preferences of the user of a content item (step 502).

For example 500, the system receives context information from an spreadsheet (uploaded by the user or retrieved from system maintained data).

Additionally, for example 500, the system generates a user interface presentation of information derived from the context information as three panels within a computer application displayed on a computer display screen. These three panels are a “branding panel”, “audience and goal panel”, and “inspiration board panel”. Together, these panels help confirm, modify, and augment the information derived from the context information. Because the system generates the input prompt that determines the brief based on the information derived from the context information, these panels (i.e., user interface) enable one or more user inputs to modify the brief to generate a final brief.

For example, the branding panel can define the core visual and thematic identity for the content item, and a user can interact with this panel by providing, confirming, modifying information presented in the user interface. For example, sliders, buttons, menus, and so can be used to select colors, fonts, and so on.

As another example, the audience and goal panel can define who will be presented the content item (i.e., a target audience) and what the content item aims to achieve. Therefore, a user can interact with this panel by to define their target audience and the intended target audience experience. For example, a user can modify a text field present in the panel to define a target audience as “fans of race car competitions” and modify another text field to define the intended experience as “excited”.

As another example, the inspiration board panel can be used for a user to define styles or descriptions that the content item will incorporate. For example, a user can drag and drop images into the panel and generate descriptions of identified portions of the image, e.g., as described above. Also, the images can be used to generate styles the content item should have, e.g., as described above.

The system generates, from the context information, an input prompt to a generative neural network (step 504).

For example, 500, the system generates the input prompt from a template prompt and the information in the user interface described above.

For example, the template prompt includes “Please use the fonts: {LIST OF FONTS}”, where “{LIST OF FONTS}” is a placeholder for fonts. The information in the user interface could include the list of fonts “Italic, Bold, and Regular” selected in the branding panel so that the generated input prompt includes “Please use the fonts: Italic, Bold, and Regular”.

The system processes the input prompt using the generative neural network to generate a brief (step 506).

For example 500, the generative neural network is a Gemini (as described in arXiv:2312.11805).

The system provides the brief of the customized content item for presentation to the user (step 508).

For example 500, the brief is displayed on a computer display screen and includes three sections: summary, detailed background, detailed foreground. For example, just as was the case for example brief 110 displayed in FIG. 1B.

The system processes an input that includes the brief using another generative neural network to generate the customized content item (step 510).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a request to generate a customized content item for a user;
receiving context information characterizing preferences of the user for the customized content item;
generating, from the context information, an input prompt to a generative neural network;
processing the input prompt using the generative neural network to generate a brief of the content item that comprises a natural language description of a content and an appearance of the customized content item; and
providing the brief of the customized content item for presentation to the user on a user device.

2. The method of claim 1, further comprising:
processing an input comprising the brief using a second generative neural network to generate the customized content item.

3. The method of claim 2, further comprising:
receiving, from the user device, a user input approving the brief, wherein processing the brief using a second generative neural network to generate the customized content item comprises processing the brief using the second generative neural network to generate the customized content item in response to receiving the user input approving the brief.

4. The method of claim 1, further comprising:
receiving, from the user device, one or more user inputs modifying the brief to generate a final brief.

5. The method of claim 4, further comprising:
providing the final brief for use in generating the customized content item.

6. The method of claim 4, further comprising:
processing an input comprising the final brief using a second generative neural network to generate the customized content item.

7. The method of claim 1, wherein the brief comprises a natural language summary of the content item.

8. The method of claim 1, wherein the brief comprises a natural language description of a background of the customized content item.

9. The method of claim 1, wherein the brief comprises a natural language description of a foreground of the customized content item.

10. The method of claim 1, wherein generating, from the context information, an input prompt to a generative neural network comprises:
generating, from the context information, a user interface presentation that presents information derived from the context information;
providing the user interface presentation for presentation to the user on the user device;
while the user interface presentation is presented on the user device, receiving a user input requesting to generate the brief; and
generating the input prompt based on information presented in the user interface presentation.

11. The method of claim 10, wherein generating, from the context information, an input prompt to a generative neural network further comprises:
prior to receiving the user input requesting to generate the brief, receiving one or more user inputs representing modifications to the information presented in the user interface presentation.

12. The method of claim 10, wherein the information presented in the user interface comprises one or more images; and wherein generating the brief based on information presented in the user interface presentation comprises:
processing each of the one or more images using a computer vision neural network to generate a description of the image; and
including, in the input prompt, the descriptions of the one or more images.

13. The method of claim 10, wherein generating, from the context information, an input prompt to a generative neural network further comprises:
processing at least a portion of the context information using the generative neural network to generate at least a portion of the information presented in the user interface presentation.

14. A system comprising one or more computers and one or more storage devices storing instructions that when executed by the one or more computers cause the one more computers to perform operations, the operations comprising:
receiving a request to generate a customized content item for a user;
receiving context information characterizing preferences of the user for the customized content item;
generating, from the context information, an input prompt to a generative neural network;
processing the input prompt using the generative neural network to generate a brief of the content item that comprises a natural language description of a content and an appearance of the customized content item; and
providing the brief of the customized content item for presentation to the user on a user device.

15. The system of claim 14, further comprising:
processing an input comprising the brief using a second generative neural network to generate the customized content item.

16. The system of claim 15, the operations further comprising:
receiving, from the user device, a user input approving the brief, wherein processing the brief using a second generative neural network to generate the customized content item comprises processing the brief using the second generative neural network to generate the customized content item in response to receiving the user input approving the brief.

17. The system of claim 14, the operations further comprising:
receiving, from the user device, one or more user inputs modifying the brief to generate a final brief.

18. The system of claim 17, the operations further comprising:
providing the final brief for use in generating the customized content item.

19. The system of claim 17, the operations further comprising:
processing an input comprising the final brief using a second generative neural network to generate the customized content item.

20. One or more non-transitory computer storage media storing instructions that when executed by one or more computers cause the one more computers to perform operations, the operations comprising:
receiving a request to generate a customized content item for a user;
receiving context information characterizing preferences of the user for the customized content item;
generating, from the context information, an input prompt to a generative neural network;
processing the input prompt using the generative neural network to generate a brief of the content item that comprises a natural language description of a content and an appearance of the customized content item; and
providing the brief of the customized content item for presentation to the user on a user device.
